(19) United States
(12) Patent Application Publication
(10) Pub. No.: US 2026/0312969 A1
(43) Pub. Date: Oct. 8, 2026

(54) METHODS AND SYSTEMS FOR PREDICTING UPCOMING ANOMALOUS EVENTS

(71) Applicant: MASTERCARD INTERNATIONAL INCORPORATED, PURCHASE, NY (US)

(72) Inventors: Alekhya BHATRAJU, Vijayawada (IN); Aditi RANI, Kangra (IN); Debasmita DAS, Lake St Louis, MO (US); Nishant PANT, Dehradun (IN); Yatin KATYAL, Rohtak (IN)

(21) Appl. No.: 19/171,076

(22) Filed: Apr. 4, 2025

(51) Int. Cl. H04L 9/40

(52) U.S. Cl. CPC H04L 63/1425

(57) ABSTRACT

Methods and systems for predicting upcoming anomalous events are disclosed. The method performed by a server system includes accessing multiple features corresponding to each entity in an entity set for determining a series of feature sets for a series of time steps for each entity. Method includes determining a count of entities from the entity set that have experienced a historical anomalous event at distinct historical time step(s). In response to determining that the count is at least equal to a threshold count, method includes labeling each entity in the entity set with an anomalous label. Method includes generating, by a Machine Learning (ML) model associated with the server system, an anomaly score indicating a likelihood of the entity set to experience an upcoming anomalous event at an upcoming time step for the entity set to generate a prediction for the upcoming anomalous event.

### TECHNICAL FIELD

The present disclosure relates to artificial intelligence-based processing systems and, more particularly, to electronic methods and complex processing systems for predicting upcoming anomalous events.

### BACKGROUND

With the advent of technology, Artificial Intelligence (AI) or Machine Learning (ML) models or algorithms have been used in almost every field, such as healthcare, education, finance, etc., among other fields. Such models are used to perform a variety of tasks, such as classification tasks, anomaly detection, pattern recognition, speech recognition, and so on. The classification tasks can be speech recognition, image classification, fraud detection, medical diagnostic testing, email spam detection, etc., among other classification tasks. All these tasks are associated with predictions that are generated either in real-time or for future events (e.g., an upcoming cyber-attack). For example, a financial enterprise can predict whether an ongoing payment transaction is fraudulent or not using such AI or ML models. More specifically, the financial enterprise can train a fraud detection model to predict the likelihood of a payment transaction being fraudulent based on the historical behavior of a cardholder performing the payment transaction. Based on these predictions, the financial enterprise takes preventive measures to incur the loss caused by the fraudulent activity.

However, some of the applications where predictions are generated for an ongoing task (i.e., generating real-time predictions) face unavoidable consequences. More specifically, as an anomalous event has already occurred, early predictions of such an event immediately after the occurrence of the event may help in the early repair of the damage caused by the corresponding event. However, conventional approaches fail to recover the damage completely. The inability to completely recover the damage caused by the anomalous event enforces losses such as financial losses on the users. For example, the prediction of fraud for an ongoing payment transaction or a completed payment transaction helps in preventing the continuation of the fraud and taking action against the same. However, the actions taken against the fraud upon its detection do not guarantee a complete recovery of the lost funds. Similarly, in an example of healthcare, failing to detect anomalies in patient data early could result in critical health complications.

In another example of a Bank Identification Number (BIN) attack, fraudsters can perform a brute-force method to guess possible card numbers. BIN refers to the first four to eight digits of a payment card. A BIN attack is a type of attack on the BIN of financial institutions as these numbers are public knowledge. Further, the fraudsters test the guessed cards by performing a series of small transactions with each number until they succeed. Once a card is successfully used to perform a first fraudulent transaction, then the fraudster can continue to commit fraud using the stollen credentials until the fraudulent activity is detected and addressed. As a result, businesses lose funds on a large scale as there is no guarantee of complete recovery of the stolen amount. Moreover, it is required for them to invest in fraud investigation processes and damage control and provide reimbursements to the consumers. Further, there are high chances of market standing and consumer confidence being lost, hampering the public reputation of the businesses.

To address this problem, approaches involving a prior prediction of future events such as anomalous events are required. For example, conventionally, weather forecasts at a particular location and at a future time instant can be predicted using an AI or ML model. The model can be trained to predict the likelihood of the occurrence of a particular type of weather condition (i.e., rainy, windy, sunny, etc.) at a particular location and at a particular future time instant. Based on these predictions, individuals may be prepared for upcoming weather conditions. However, using such methods it may be difficult to get accurate predictions for future anomalous events leading to missing on some attacks, which in turn causes losses. It is noted that conventional approaches provide false positives, as a vast amount of data is considered for training the ML models causing the models to learn incorrect or irrelevant patterns and provide irrelevant results in some scenarios. Moreover, some conventional approaches decline high-confidence transactions which leave some room for fraud to pass through.

Thus, there exists a need for technical solutions, such as improved methods and systems for predicting upcoming anomalous events while overcoming the aforementioned technical drawbacks.

### SUMMARY

Various embodiments of the present disclosure provide methods and systems for predicting upcoming anomalous events.

In an embodiment, a computer-implemented method for predicting upcoming anomalous events is disclosed. The computer-implemented method performed by a server system includes accessing a plurality of features corresponding to each entity in an entity set from a database associated with the server system. The computer-implemented method further includes determining a series of feature sets for a series of time steps for each entity based, at least in part, on the plurality of features. Herein, an individual feature set in the series of feature sets corresponds to an individual time step. Further, the computer-implemented method includes determining a count of one or more entities from the entity set that have experienced a historical anomalous event at one or more distinct historical time steps based, at least in part, on the corresponding plurality of features of the one or more entities. In response to determining that the count is at least equal to a threshold count, the computer-implemented method includes labeling each entity in the entity set with an anomalous label. Furthermore, the computer-implemented method includes generating, by a Machine Learning (ML) model associated with the server system, an anomaly score for the entity set based, at least in part, on the corresponding series of feature sets and the labeling step. Herein, the anomaly score indicates a likelihood of the entity set to experience an upcoming anomalous event at an upcoming time step. Moreover, the computer-implemented method includes generating, by the ML model, a prediction for the upcoming anomalous event based, at least in part, on the anomaly score and a prediction threshold.

In another embodiment, a server system is disclosed. The server system includes a communication interface and a memory including executable instructions. The server system also includes a processor communicably coupled to the communication interface and the memory. The processor is configured to execute the instructions to cause the server system, at least in part, to access a plurality of features corresponding to each entity in an entity set from a database associated with the server system. Further, the server system is caused to determine a series of feature sets for a series of time steps for each entity based, at least in part, on the plurality of features. Herein, an individual feature set in the series of feature sets corresponds to an individual time step. Furthermore, the server system is caused to determine a count of one or more entities from the entity set that have experienced a historical anomalous event at one or more distinct historical time steps based, at least in part, on the corresponding plurality of features of the one or more entities. In response to determining that the count is at least equal to a threshold count, the server system is caused to label each entity in the entity set with an anomalous label. Thereafter, the server system is caused to generate, by a Machine Learning (ML) model associated with the server system, an anomaly score for the entity set based, at least in part, on the corresponding series of feature sets and the labeling step. Herein, the anomaly score indicates a likelihood of the entity set to experience an upcoming anomalous event at an upcoming time step. The server system is further caused to generate, by the ML model, a prediction for the upcoming anomalous event based, at least in part, on the anomaly score and a prediction threshold.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a plurality of features corresponding to each entity in an entity set from a database associated with the server system. Further, the method includes determining a series of feature sets for a series of time steps for each entity based, at least in part, on the plurality of features. Herein, an individual feature set in the series of feature sets corresponds to an individual time step. The method further includes determining a count of one or more entities from the entity set that have experienced a historical anomalous event at one or more distinct historical time steps based, at least in part, on the corresponding plurality of features of the one or more entities. In response to determining that the count is at least equal to a threshold count, the method includes labeling each entity in the entity set with an anomalous label. Furthermore, the method includes generating, by a Machine Learning (ML) model associated with the server system, an anomaly score for the entity set based, at least in part, on the corresponding series of feature sets and the labeling step. Herein, the anomaly score indicates the likelihood of the entity set to experience an upcoming anomalous event at an upcoming time step. Moreover, the method includes generating, by the ML model, a prediction for the upcoming anomalous event based, at least in part, on the anomaly score and a prediction threshold.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present disclosure, reference is now made to the following descriptions taken in connection with the accompanying drawings in which:

FIG. 1 illustrates a schematic representation of an environment related to at least some example embodiments of the present disclosure;

FIG. 2 illustrates a simplified block diagram of a server system, in accordance with an embodiment of the present disclosure;

FIG. 3 illustrates a schematic representation of an architecture for predicting upcoming anomalous events, in accordance with an embodiment of the present disclosure;

FIG. 4 illustrates a schematic representation of an architecture of a Machine Learning (ML) model used for predicting the upcoming anomalous events, in accordance with an embodiment of the present disclosure;

FIG. 5 illustrates a schematic representation of another environment related to at least some example embodiments of the present disclosure;

FIG. 6 illustrates a flow diagram depicting a method for predicting upcoming anomalous events in a financial domain, in accordance with an embodiment of the present disclosure; and

FIG. 7 illustrates a flow diagram depicting a method for predicting upcoming anomalous events, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

Further, the terms “cardholder”, “user”, “account holder”, “consumer”, and “buyer” are used interchangeably throughout the description and refer to a person who has a payment account or at least one payment card (e.g., credit card, debit card, etc.). The payment card may or may not be associated with the payment account and will be used by a merchant to complete the payment transaction initiated by the cardholder. The payment account may be opened via an issuing bank or an issuer server.

The term “merchant”, used throughout the description generally refers to a seller, a retailer, a purchase location, an organization, or any other entity that is in the business of selling goods or providing services. Moreover, it can refer to either a single business location or a chain of business locations of the same entity.

The term “payment account” used throughout the description refers to a financial account that is used to fund a financial transaction. Examples of the financial account include, but are not limited to, a savings account, a credit account, a checking account, and a virtual payment account.

The terms “payment transaction”, “financial transaction”, “e-commerce transaction”, “digital transaction”, and “transaction” are used interchangeably throughout the description and refer to a transaction of a payment of a certain amount being initiated by the cardholder.

The term “issuer”, used throughout the description, refers to a financial institution normally called an “issuer bank” or “issuing bank” in which an individual or an institution may have an account. The issuer also issues a payment card, such as a credit card, a debit card, etc. Further, the issuer may also facilitate online banking services, such as electronic money transfer, bill payment, etc., to the cardholders through a server which is called “issuer server” throughout the description.

The term “acquirer”, used throughout the description, refers to a financial institution (e.g., a bank) that processes financial transactions for merchants. In other words, this can be an institution that facilitates the processing of payment transactions for physical stores, merchants, or institutions that own platforms that make either online purchases or purchases made via software applications possible (e.g., the shopping cart platform providers and the in-app payment processing providers).

The terms “payment network” and “card network” are used interchangeably throughout the description and refer to a network or collection of systems used for the transfer of funds using cash substitutes. Payment networks may use a variety of different protocols and procedures to process the transfer of money for various types of transactions. Payment networks are companies that connect an issuing bank with an acquiring bank to facilitate online payment. It is noted that the payment networks are operated by organizations that are called “payment processors” throughout the description.

The terms “payment card” and “card” are used interchangeably throughout the description and refer to a physical or virtual card that may or may not be linked with a financial or payment account. It may be presented to a merchant or any such facility to fund a financial transaction via the associated payment account. Examples of payment cards include, but are not limited to, debit cards, credit cards, prepaid cards, virtual payment numbers, virtual card numbers, forex cards, charge cards, e-wallet cards, and stored-value cards.

### Overview

Various embodiments of the present disclosure provide methods, systems, electronic devices, and computer program products for predicting upcoming anomalous events. In one embodiment, the present disclosure describes a server system that is configured to access an entity-related dataset from a database associated with the server system. The entity-related dataset may include information related to a plurality of entities. The server system may further be configured to generate a plurality of features corresponding to each entity based, at least in part, on the information related to the plurality of entities that may be stored in the database. In an embodiment, the server system is configured to generate an entity set including one or more entities and one or more related entities based, at least in part, on the plurality of features corresponding to each entity in the plurality of entities. The one or more related entities may be identified from the plurality of entities based on a predefined relation condition.

In a non-limiting implementation, the server system may access the plurality of features corresponding to each entity in the entity set from the database. The server system may determine a series of feature sets for a series of time steps for each entity based, at least in part, on the plurality of features. Herein, an individual feature set in the series of feature sets corresponds to an individual time step. In a specific embodiment, the server system may determine a count of one or more entities from the entity set that have experienced a historical anomalous event at one or more distinct historical time steps based, at least in part, on the corresponding plurality of features of the one or more entities. In response to determining that the count is at least equal to a threshold count, the server system may label each entity in the entity set with an anomalous label. Alternatively, in response to determining that the count is less than the threshold count, the server system may label each entity in the entity set with a non-anomalous label.

Further, the server system may access a series of normalized feature sets for the series of time steps from the database for training a Machine Learning (ML) model. It is noted that the server system may be configured to train the ML model to generate the prediction for the upcoming anomalous event based, at least in part, on the series of normalized feature sets and the labeling step. In an embodiment, the server system is configured to generate the series of normalized feature sets for the series of time steps for each entity based, at least in part, on the series of feature sets and a normalization condition. These series of normalized feature sets are stored in the database and are accessible for training the ML model. More specifically, for training the ML model, the server system may access a series of normalized training feature sets for a series of training time steps corresponding to each training entity set of one or more training entity sets from the database. The server system may also access a true label corresponding to each training entity in each training entity set from the database. Herein, the true label may correspond to one of the anomalous label or the non-anomalous label. Further, the server system may initialize the ML model with one or more model parameters.

Later, in an embodiment, the server system may have to perform a set of operations using the ML model, iteratively, until convergence criteria are met for training the ML model. The set of operations can be explained as a configuration of the server system for the simplicity of the explanation. The server system may be configured to generate a predicted probability score for each training entity set based, at least in part, on the series of normalized training feature sets for each training entity set. The predicted probability score may indicate a likelihood of at least one training entity set of the one or more training entity sets to experience the upcoming anomalous event at an upcoming training time step. Further, the server system may generate a prediction for the upcoming anomalous event based, at least in part, on the predicted probability score and the prediction threshold. The prediction may include the at least one training entity set that is likely to experience the upcoming anomalous event at the upcoming training time step. Then, the server system may compute a prediction loss for each training entity set based, at least in part, on the prediction and the corresponding true label for the corresponding training entity set. Later, the server system may optimize the one or more model parameters based, at least in part, on the prediction loss.

Once the ML model is trained, the server system may be configured to generate an anomaly score for the entity set based, at least in part, on the corresponding series of feature sets and the labeling step. Herein, the anomaly score may indicate a likelihood of the entity set to experience an upcoming anomalous event at an upcoming time step. Thereafter, the server system may generate a prediction for the upcoming anomalous event based, at least in part, on the anomaly score and a prediction threshold. In response to the anomaly score being at least equal to the prediction threshold, the server system may generate the prediction indicating that the entity set is likely to experience the upcoming anomalous event at the upcoming time step. Alternatively, in response to the anomaly score is less than the prediction threshold, the server system may generate the prediction indicating that the entity set is not likely to experience the upcoming anomalous event at the upcoming time step.

In some embodiments, the server system may generate periodically an alert for at least the entity set and a managing entity with a predefined period in response to the generation of the prediction for the upcoming anomalous event. In a specific embodiment, the server system may compute a feature importance metric associated with each feature from the plurality of features based, at least in part, on a contribution of the corresponding feature to the prediction of the ML model. Further, the server system may determine a set of relevant features from the plurality of features based, at least in part, on the feature importance metric associated with each feature and an importance threshold. The set of relevant features may be used to refine the prediction.

Various embodiments of the present disclosure offer multiple advantages and technical effects. For instance, the present disclosure aims to solve the technical problem of accurately predicting anomalous events such as frauds ahead of the actual time of the occurrence of the corresponding event. More specifically, it solves the problem of predicting anomalous events in advance by effectively selecting relevant input features for training an ML model to predict such events. Thus, the proposed approach is advantageous in terms of proactive risk management, fraud prevention, enhancing users'trust, cost saving, improving operational efficiency, retaining business reputation, and the like. Overall, it is noted that effective prediction and prevention provide a competitive edge for businesses, attracting security-conscious consumers, and enhancing market positioning. Further, pre-emptive anomalous event detection enables proactive decision-making to mitigate risks before they escalate, eliminating the generation of false positives.

The proposed approach considers features such as existing fraudulent scores, data patterns of relevant features, and data from other relevant data sources to train the ML model for providing predictions for large-scale anomalous events such as large-scale fraud attacks. Moreover, the alerts are generated on a daily basis and not upon the completion of a particular transaction, making the proposed approach more dynamic in nature in comparison to conventional approaches. In addition, the proposed approach allows for a thorough analysis and cross-referencing of input data to select only relevant input features, making the proposed approach cost-effective. It is noted that the proposed approach helps to identify trends and patterns that may not be evident in real-time data as it provides a broader historical context for predicting upcoming anomalous events. The proposed approach also enables the generation of detailed reports and analyses having scores that can also be utilized by conventional approaches to enhance their operations.

For example, early prediction enables financial institutions to implement preventive measures, reducing the risk of fraudulent attacks such as Bank Identification Number (BIN) attacks. By generating time series data from relevant features associated with a payment card set (or an Account Range), patterns associated with the payment card set can be learned more accurately. An ML model trained using such time series data can generate an accurate prediction for upcoming fraudulent activities well in advance. Thus, it is noted that anticipating attacks in advance allows for stricter fraud detection mechanisms, minimizing fraudulent transactions. Predictive measures reassure the users or the cardholders about the safety of their financial data, building trust and loyalty. In addition, it saves costs associated with fraud investigations, reimbursements, chargeback processing, and damage control. Furthermore, streamlined threat identification allows targeted and efficient security measures. More specifically, preventing attacks such as BIN attacks protects the institution's reputation, maintaining consumer confidence, and market standing.

In another example, within the healthcare industry, the proposed approach can be used to analyze patient health data (e.g., heart rate, blood pressure, lab results) to predict the likelihood of conditions like heart attacks, strokes, or diabetes before symptoms appear. Further, generating the health data in a time series fashion (e.g., data about the health conditions of the patients on a daily basis) helps an ML model to accurately learn various patterns in the health data. Thus, it is noted that anticipating severe health conditions of the patients in advance allows for the healthcare facilities to be prepared with the necessary equipment and medicines to provide immediate cures to the patients. Also, the treatment can be started well in advance to avoid the occurrence of the predicted severe medical condition of the patients.

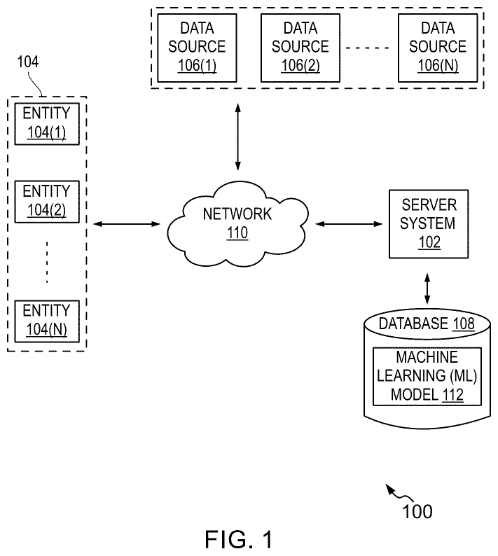

Various example embodiments of the present disclosure are described hereinafter with reference to FIG. 1 to FIG. 7.

FIG. 1 illustrates a schematic representation of an environment 100 related to at least some example embodiments of the present disclosure. Although the environment 100 is presented in one arrangement, other embodiments may include the parts of the environment 100 (or other parts) arranged otherwise depending on, for example, determining a series of feature sets for a series of time steps for each entity in an entity set, determining a count of entities from the entity set that have experienced historical anomalous events to be at least equal to a threshold count to label them with an anomalous label, generating an anomaly score for the entity set using a Machine Learning (ML) model, generating a prediction for an upcoming anomalous event for the entity set using the ML model, and the like.

The environment 100, generally includes a plurality of parties, such as a server system 102, a plurality of entities 104(1), 104(2), . . . 104(N) (collectively referred to hereinafter as the ‘plurality of entities 104’ or simply, ‘entities 104’), a plurality of data sources 106(1), 106(2), . . . 106(N) (collectively referred to hereinafter as a ‘plurality of data sources 106’ or simply, ‘data sources 106’), a database 108, each coupled to, and in communication with (and/or with access to) a network 110. Herein, ‘N’ is a non-zero natural number and may be different for each distinct entity.

In one embodiment, the server system 102 may be used by a managing entity (not shown) to train a Machine Learning (ML) model (e.g., the ML model 112) to predict an upcoming anomalous event. The upcoming anomalous event may occur in the future at a particular time instant. The ML model 112 can be applicable in multiple applications, fields, or domains, such as financial domain, healthcare domain, manufacturing domain, environment-related domain, transportation domain, social media domain, and the like, to address problems, such as fraud detection, disease prevention, predictive maintenance, disaster management, traffic management, content moderation, and the like, respectively.

In financial domain, examples of the anomalous event can include, but are not limited to, a cyber-attack, a market crash in the stock market, loan default risk, etc. In healthcare domain, examples of the anomalous event can include, but are not limited to, heart attack, stroke, diabetic spike, infection and disease outbreak, depression, anxiety attack, etc. In environment and disaster management, examples of the anomalous event can include, but are not limited to, earthquakes, hurricanes, floods, forest fires, hazardous environmental conditions, etc. Thus, it may be understood that anomalous events are different for different applications. It is noted that any anomalous event in any application can be predicted using the ML model 112 trained using the proposed approach in the present disclosure.

In a non-limiting implementation, the managing entity may be any individual, representative of a person, an institution, an organization, a corporate entity, a non-profit organization, a financial institution, a bank, medical facilities (e.g., hospitals, laboratories, etc.), educational institutions, government agencies, telecom industries, or the like. In an example, the managing entity may be an administrator of the server system 102.

In one embodiment, the entities 104 may include individuals, objects, or concepts that may or may not interact with each other or are related or unrelated to each other. For example, the entity (e.g., the entity 104(1)) may include any individual, representative of a person, an object, an identifier of a person, a place or a location, an institution, an organization, a corporate entity, a non-profit organization, a financial institution, a bank, a cardholder, a merchant, medical facilities (e.g., hospitals, laboratories, etc.), educational institutions, government agencies, telecom industries, or the like.

In a specific embodiment, data associated with the entities (e.g., the entities 104) is used for training the ML model 112. The data associated with the entities 104 can be referred to as an ‘entity-related dataset’, which may be stored in the database 108. For instance, the entities 104 may be patients who are undergoing treatment for certain diseases. Data corresponding to such patients can be used to learn and understand the experience of the patients at a particular clinical center. Thus, such data is used to train AI or ML models to identify diseases and diagnoses. For example, classifying different diseases, such as cancer using images, predicting the progression of pre-diabetes, predicting responses to depression treatment, etc. In the present disclosure, the data of the patients is used to train the ML model 112 to predict the upcoming anomalous event at upcoming time steps, such as an upcoming alarming health condition (e.g., a heart attack) in the next seven days.

In another instance of a weather forecasting application, the entities 104 may correspond to individuals who provide information, such as location, date and time, preferences, alerts, activities, and the like. In accordance with the proposed approach, the information provided by such individuals can be used to generate predictions related to weather that are more personalized and actionable. For example, preferences of the individuals influence how the weather forecast data is presented to the entity (e.g., the entity 104(1)), while activity details can enable the application to highlight relevant weather conditions (e.g., rain or wind for outdoor plans) for the entity 104(1) in advance.

In yet another instance of a payment industry, the entities 104 may be cardholders, account holders, merchants, consumers, issuers, acquirers, third-party users, financial institutions, or the like. Data related to such individuals include historical financial transaction-related data, income-related data, expenditure-related data, cardholder demographics, credit scores, fraudulent transactions, transaction patterns, anomalies, compliance data, and the like. Further, in an example of the transportation and logistics industry, the entity-related dataset can include route information, time information, traffic information, weather information, vehicle information, external events, and the like. In accordance with the proposed approach, such data can be used to train the ML model 112 to predict an upcoming alarming event such as fraud (e.g., a Bank Identification Number (BIN) attack) on a group of entities of the entities 104 at upcoming time steps (e.g., in next seven days) in advance.

Thus, it may be understood that the entity-related dataset can include different information specific to any field of operation, such as the payment industry, the medical industry, the transportation and logistics industry, and the like. Further, the various embodiments of the present disclosure apply to a variety of different fields of operation, and the same is covered within the scope of the present disclosure.

In a specific embodiment, the data sources 106 may correspond to various data sources that may be associated with the server system 102. In a non-limiting example, the data sources 106 can be responsible for collecting and collating data related to the entities 104 and their surroundings. Herein, the data sources 106 may act as a data provider for the server system 102 and a data collector for the entities 104. In one embodiment, the data sources 106 can collect data from the entities 104 and via the network 110. It may be noted that the data sources 106 may be independent institutions that are independent of the entities 104 or may be associated with the entities 104. In another embodiment, the data sources 106 can include satellites, data gathering stations, sensors, and the like. Thus, the data sources 106 may directly collect data from its environment and provide it to the server system 102 upon receiving a request. Further, in an embodiment, the data sources 106 may be local storage units or cloud/remote storage units. In another embodiment, the data sources 106 may be owned by third-party organizations.

In a non-limiting example, each data source of the data sources 106 may collect and store data pertaining to a particular or specific task. For instance, the data sources 106 may be a data source for collecting and storing payment transaction-specific data. To that end, the data sources 106 may be an issuer server associated with an issuing bank, an acquirer server associated with an acquiring bank, a payment server associated with a payment network, or the like. In such an instance, the server system 102 may be embodied within the payment server. In another instance, the data sources 106 may be a medical-specific data repository associated with a hospital server that collects and stores a plurality of patient-related details, medical authorities-related details, staff details, medical students'details, and the like. In yet another instance, the data sources 106 for weather forecasting applications can be weather stations, sensors, radiosondes, aircraft and ships, radar, etc.

In some embodiments, the data sources 106 can be hidden platforms such as a dark website or a dark network. These platforms include data, such as stolen data, illegal services-related data, drugs, weapons, counterfeit money, articles, publications, etc., among other data that is leaked to these platforms illegally.

It may be noted that the server system 102 is configured to collect data from data sources such as the data sources 106 to analyze and understand historical anomalous event patterns in the data. These historical anomalous event patterns may be different for different entities 104 based on their historical behavior. The server system 102 is configured to train the ML model 112 with this data, for the ML model 112 to be able to predict similar events (i.e., upcoming anomalous events) that can possibly occur in the future.

In a specific embodiment, the server system 102 receives data from the entities 104 through the data sources 106. In another embodiment, the server system 102 receives data from the data sources 106, wherein the data is related or unrelated to the entities 104. The server system 102 may store received data in the database 108 as the entity-related dataset. In an embodiment, the database 108 is also configured to store various AI or ML models such as the ML model 112. Various examples of the ML model 112 can include Convolutional Neural networks (CNNs), Recurrent Neural networks (RNNs), Long-Short Term Memory (LSTM) networks, Bi-LSTM networks, and the like.

In another embodiment, the database 108 can also store other necessary machine instructions required for implementing the various functionalities of the server system 102 such as firmware data, operating system, and the like. In addition, the database 108 provides a storage location for data and/or metadata obtained from various operations performed by the server system 102.

In one embodiment, the database 108 may be incorporated in the server system 102 or maybe an individual entity connected to the server system 102 or maybe a database stored in cloud storage. In various non-limiting examples, the database 108 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a Redundant Array of Independent Disks (RAID) controller, a Storage Area Network (SAN) adapter, a network adapter, and/or any component providing the server system 102 with access to the database 108. In one implementation, the database 108 may be viewed, accessed, amended, updated, and/or deleted by an administrator (not shown) associated with the server system 102 through a Database Management System (DBMS) or Relational Database Management System (RDBMS) present within the database 108.

In some embodiments, the entities 104 may use their corresponding electronic devices (not shown in figures) to access a platform, such as a mobile application or a website associated with any third-party application, to perform various tasks. Examples of the tasks can be to purchase items made available by certain merchants, to request a doctor's appointment, and so on. In various non-limiting examples, the electronic devices may refer to any electronic devices, such as, but not limited to, Personal Computers (PCs), tablet devices, smart wearable devices, Personal Digital Assistants (PDAs), voice-activated assistants, Virtual Reality (VR) devices, smartphones, laptops, and the like.

In various embodiments, the network 110 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or entities illustrated in FIG. 1, or any combination thereof. Various entities in the environment 100 may connect to the network 110 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 110 may utilize a secure protocol (e.g., Hypertext Transfer Protocol (HTTP), Secure Socket Lock (SSL), and/or any other protocol, or set of protocols for communicating with the various entities depicted in FIG. 1.

As may be understood, AI or ML models trained using conventional approaches are associated with technical problems that are as described earlier in the present disclosure. Therefore, the above-mentioned technical problems, among other problems, are addressed by one or more embodiments implemented by the server system 102 and the methods thereof provided in the present disclosure.

In an embodiment, the entities 104 may be associated with entity identifiers, with an individual entity identifier corresponding to an individual entity (e.g., the entity 104(1)). In a non-limiting example, the entity 104(1) can be associated with multiple entity identifiers with the entity identifier designated to perform a separate task. For example, in the financial industry, the entity identifiers can be a payment card, a payment card number, an account number, or the like associated with the cardholders. As may be understood, the entity-related dataset may include data or information related to the entities 104. To use this information for training the ML model 112, the server system 102 may generate features or extract the features corresponding to each entity based on the entity-related dataset and store them in the database 108. In an embodiment of the present disclosure, the server system 102 is configured to extract relevant features from the entity-related dataset, the generated features, or the extracted features for training, testing, and validating the ML model 112. In some embodiments, the relevant features may correspond to each entity. In some other embodiments, the relevant features may correspond to each entity identifier associated with an individual entity. In one example, the relevant features correspond to each cardholder. In another example, the relevant features correspond to each payment card. It is noted that the server system 102 is configured to perform various operations (explained later in the present disclosure) to extract the relevant features for training the ML model 112. Later, the server system 102 is configured to use the ML model 112 to predict a group of entities of the entities 104 that are likely to experience the upcoming anomalous event at upcoming time steps.

In a specific embodiment, the server system 102 is configured to access a plurality of features corresponding to each entity in an entity set from the database 108. In a non-limiting implementation, the entity set is a subset of the plurality of entities such as the entities 104. The entity set may be created based on a relationship between the plurality of entities 104. Further, the server system 102 may be configured to determine a series of feature sets for a series of time steps for each entity based, at least in part, on the plurality of features. An individual feature set in the series of feature sets may correspond to an individual time step.

In an embodiment, the server system 102 is configured to determine a count of one or more entities from the entity set that have experienced a historical anomalous event at one or more distinct historical time steps. The server system 102 may determine said count based, at least in part, on the corresponding plurality of features of the one or more entities. In response to determining that the count is at least equal to a threshold count, the server system 102 may label each entity in the entity set with an anomalous label. Then, the server system 102 may generate an anomaly score for the entity set based, at least in part, on the series of feature sets and the labeling step. The anomaly score may indicate a likelihood of the entity set to experience the upcoming anomalous event at an upcoming time step. In a non-limiting example, the server system 102 generates the anomaly score using the ML model 112. Further, the server system 102 may generate a prediction for the upcoming anomalous event based, at least in part, on the anomaly score and a prediction threshold. In an example, the prediction may also be generated using the ML model 112. The entire process of training the ML model 112 and generating the prediction for the upcoming anomalous event is explained later in the present disclosure.

It should be understood that the server system 102 is a separate part of the environment 100 and may operate apart from (but still in communication with, for example, via the network 110) any third-party external servers (to access data such as the training datasets to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices are shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 110, which may be specifically configured, via executable instructions, to perform steps as described herein, and/or embodied in at least one non-transitory computer-readable media.

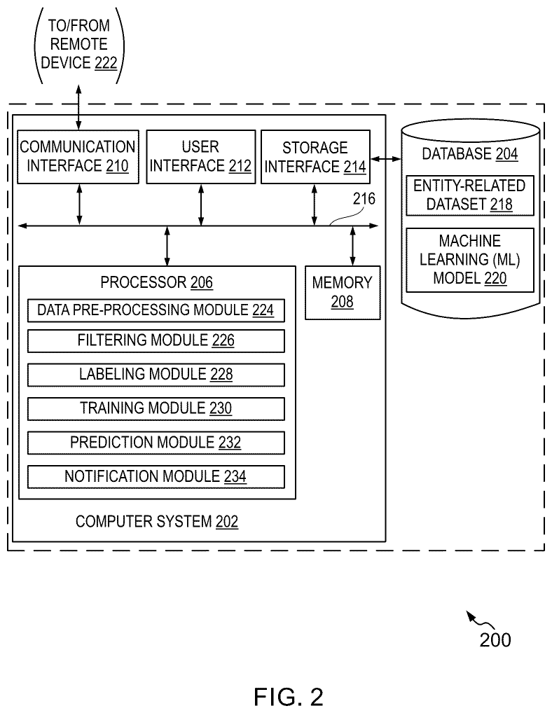

FIG. 2 illustrates a simplified block diagram of a server system 200, in accordance with an embodiment of the present disclosure. The server system 200 is substantially similar to the server system 102 of FIG. 1. In some embodiments, the server system 200 is embodied as a cloud-based and/or software-as-a-service (SaaS) based architecture.

The server system 200 includes a computer system 202 and a database 204. The computer system 202 includes at least one processor 206 (herein, referred to interchangeably as ‘processor 206’) for executing instructions, a memory 208, a communication interface 210, a user interface 212, and a storage interface 214. One or more components of the computer system 202 communicate with each other via a bus 216. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities.

In some embodiments, the database 204 is integrated into the computer system 202. In one embodiment, the database 204 is substantially similar to the database 108 of FIG. 1. In one non-limiting example, the database 204 is configured to store an entity-related dataset 218, an ML model 220, and the like. Herein, the entity-related dataset 218 is an example for the entity-related dataset described in FIG. 1. Further, the ML model 220 is an example for the ML model 112 described in FIG. 1.

Further, the computer system 202 may include one or more hard disk drives as the database 204. The user interface 212 is an interface, such as a Human Machine Interface (HMI) or a software application that allows entities 104 such as an administrator to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute operations for determining a series of feature sets for a series of time steps for each entity in an entity set, determining a count of entities from the entity set that have experienced historical anomalous events to be at least equal to a threshold count to label them with an anomalous label, generating an anomaly score for the entity set using the ML model 220, generating a prediction for an upcoming anomalous event for the entity set using the ML model 220, and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 222, such as electronic devices of the entities 104, or communicating with any entity connected to the network 110 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 224, a filtering module 226, a labeling module 228, a training module 230, a prediction module 232, and a notification module 234. It should be noted that components, described herein, such as the data pre-processing module 224, the filtering module 226, the labeling module 228, the training module 230, the prediction module 232, and the notification module 234 can be configured in a variety of ways, including electronic circuitries, digital arithmetic, and logic blocks, and memory systems in combination with software, firmware, and embedded technologies. Moreover, it may be noted that the data pre-processing module 224, the filtering module 226, the labeling module 228, the training module 230, the prediction module 232, and the notification module 234 may be communicably coupled with each other to exchange information with each other for performing the one or more operations facilitated by the server system 200.

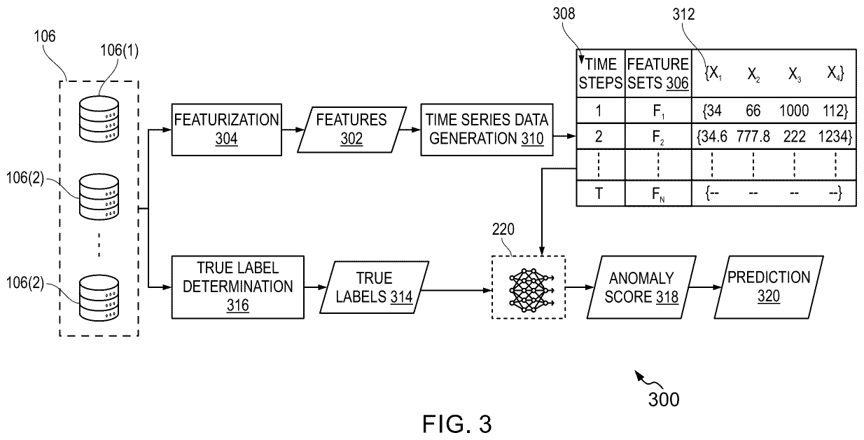

In an embodiment, the data pre-processing module 224 includes suitable logic and/or interfaces for accessing the entity-related dataset 218 from the database 204. The entity-related dataset 218 may include information related to a plurality of entities such as the entities 104. In a non-limiting example, the information can be historical information or information that is captured in real time. For instance, the information can include an interaction type, a number of interactions, entity identity-related information, a count of entities involved in an interaction, and the like, corresponding to the plurality of interactions performed between the entities 104. More specifically, in various non-limiting examples, the entity-related dataset 218 can include different information specific to any field of operation, such as the payment industry, the medical industry, the transportation and logistics industry, and the like. As may be understood, this information is obtained from different data sources such as the data sources 106 (as shown in FIG. 1 and FIG. 3).

In an embodiment, for training the ML model 220, the entity-related dataset 218 can be split, and a training dataset may be extracted. The training dataset can be a portion of the entity-related dataset 218 for a particular time period. For instance, if the entity-related dataset 218 is information related to various operations performed by the entities 104 for a period of one year, the training dataset can be the information captured over 4 months (January to April of the year 2022). During a training phase of the ML model 220, the training dataset can be referred to as an input dataset for the ML model 220. Once trained, the ML model 220 may be tested and validated using datasets from different timelines, i.e., out of the one year's data, the remaining data (excluding the training dataset) can be further split into a validation dataset and a testing dataset. It is noted that the validation dataset can include information captured for another 4 months (May to August of the year 2022). Similarly, the testing dataset can include information captured for another 4 months (September to December of the year 2022). During the validation phase of the ML model 220, the validation dataset can be referred to as the input dataset, whereas during the testing phase, the input dataset to the ML model 220 changes to the testing dataset. Further, during deployment also, the input dataset changes to a new dataset (i.e., a real-time dataset that is available during the deployment of the ML model 220).

In another embodiment, the data pre-processing module 224 is configured to generate a plurality of features (see, features 302, as shown in FIG. 3) corresponding to each entity of the entities 104 based, at least in part, on the information related to the entities 104. The process of generating the features can be referred to as ‘featurization’ (see, 304, as shown in FIG. 3). It may be noted that the featurization step may be a part of a process of preparing the entity-related dataset 218 for training the ML model 220. In various non-limiting examples, the data pre-processing module 224 can utilize any feature generation approach (otherwise also referred to as ‘featurization approach’) to generate the features. In one embodiment, the features may be extracted from the entity-related dataset 218 for each entity. In another embodiment, new features may be generated for each entity using the various data fields associated with each entity in the raw data. Both the extracted features and the newly generated features may correspond to insights, useful information, relevant patterns, and the like associated with the entity-related dataset 218. In various non-limiting examples, various featurization approaches can include removing noise, feature engineering, feature selection, data cleaning, handling missing values, normalizing or scaling data, analyzing characteristics of the data, and converting the entity-related dataset 218 into a format that any AI or ML models can process. Since such featurization approaches are well known to the person skilled in the art, the same are explained herein for the sake of brevity. Upon generating the features, they may be stored in the database 204 which is accessible for future use.

In various non-limiting examples, the features can include historical anomalous event-related features, such as an anomalous event type, a number of historical anomalous events, a number of anomalous event triggers or alerts, a number of unusual activities, and the like corresponding to each entity of the entities 104. In various other examples, the features can include features extracted from datasets derived from hidden platforms such as a dark website or the dark network. It is noted that as the ML model 220 is supposed to be trained to predict upcoming anomalous events, the entity-related dataset 218 and the features may be associated with historical anomalous events triggered by various other systems or recorded by the data sources 106.

In some embodiments, some AI or ML models may require the features to be represented in a compressed format as these models can process data only in such a format. Thus, in an embodiment, the data pre-processing module 224 is configured to generate a plurality of embeddings for the entity-related dataset 218 based on the plurality of features. The term ‘embedding’ refers to a numerical representation of data in a lower-dimensional, continuous vector space. It is noted that the embeddings capture key features and relationships between the features in compact form. As a result, it becomes easier for any AI or ML model such as the ML model 220 to work with complex data such as categorical features. In addition, by generating the embeddings for the features, dimensionality reduction, information compression, generalization, improvement in model performance, improvement in interoperability, efficient storage and transmission, enhanced privacy, and the like can be achieved across various applications. The data pre-processing module 224 may transfer the entity-related dataset 218 and pre-processed data, such as the features and/or the embeddings to the filtering module 226 and labeling module 228 for further processing.

In an embodiment, the filtering module 226 includes suitable logic and/or interfaces for accessing the features from the database 204. Further, the filtering module 226 may be configured to generate the entity set including the one or more entities and one or more related entities based, at least in part, on the features corresponding to each entity in the plurality of entities such as the entities 104. In a non-limiting implementation, the one or more related entities are identified from the plurality of entities 104 based on a predefined relation condition. It is noted that one or more entity sets may be created from the entities 104 that are subsets of the entities 104. Each entity set may include entities that are related to each other based on the predefined relation condition. For instance, the predefined relation condition can include at least one feature that is common to the entities in the entity set. For example, in the payment industry, the feature that can be common to multiple cardholders can be a BIN associated with the payment cards of the cardholders. In another example of a healthcare facility, the feature that can be common to multiple patients is a hospital. In other words, patients taking treatment from a particular hospital can be grouped together. Alternatively, patients getting treatment from a particular doctor can be grouped together.

In another embodiment, the filtering module 226 is configured to determine a series of feature sets (see, 306, as shown in FIG. 3) for a series of time steps (see, 308, as shown in FIG. 3) for each entity based, at least in part, on the plurality of features. Herein, an individual feature set in the series of feature sets corresponds to an individual time step. This process may be referred to as ‘time series data generation’ or ‘time sequence data generation’ (see, 310, as shown in FIG. 3). For instance, each time step can correspond to each day, and an individual feature set may be extracted for each day from the features corresponding to each entity in the entity set.

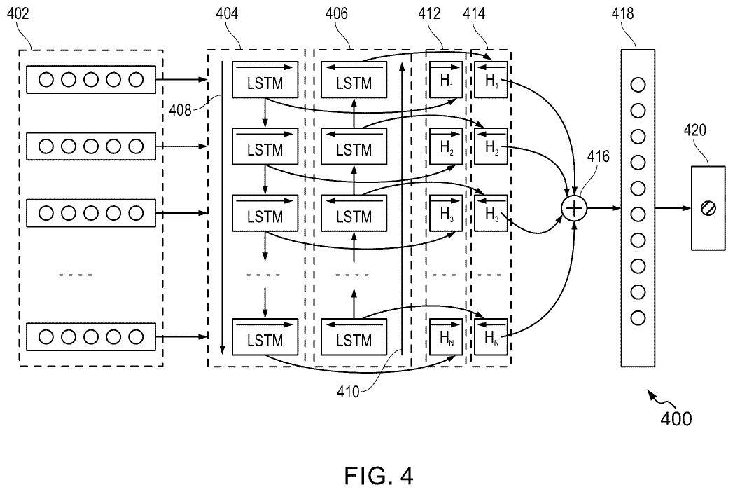

Referring to FIG. 3, a schematic representation of an architecture 300 for predicting upcoming anomalous events, in accordance with an embodiment of the present disclosure. In an example scenario, the features can include features, such as X₁, X₂, X₃, and X₄ (see, 312). It is noted that these features have different values at different time steps or time instants, such as 1, 2, 3, . . . and so on. It is noted that a metric for the time steps can be minutes, hours, days, weeks, or the like. An individual feature set can include values for {X₁, X₂, X₃, X₄} at an individual time step such as time step ‘1’. For example, the feature sets such as F₁, F₂, . . . and so on till F_{N} can be {34, 66, 1000, 112}, {34.6, 777.8, 2222, 1234}, . . . and so on for time steps 1, 2, 3, . . . and so on till time ‘T’, respectively (see, 402, as shown in FIG. 4).

In an example of the payment industry, consider features including total transaction with response code 43 (i.e., with stolen cards), total transaction amount made using the stolen cards, total declined amount from CNP domestic transactions, and total domestic CNP transaction count having a risk score in a predefined range. For these features, the series of feature sets for the series of time steps can include different values (i.e., each feature set) for these features for each time step (e.g., each day). For instance, two transactions with stolen cards or a total amount of 150 US dollars (USD), 500 USD being declined amount from CNP transactions, and 5 transactions having the risk score in the predefined range on a particular day, four transactions with stolen cards or a total amount of 200 USD, 1000 USD being declined amount from CNP transactions, and 10 transactions having the risk score in the predefined range on a particular day, and so on in the series of 90 days considered for training the ML model 220.

Referring back to FIG. 2, in an embodiment, the labeling module 228 includes suitable logic and/or interfaces for determining a count of one or more entities from the entity set that have experienced a historical anomalous event at one or more distinct historical time steps based, at least in part, on the corresponding plurality of features of the one or more entities. In response to determining that the count is at least equal to a threshold count, the labeling module 228 may label each entity in the entity set with an anomalous label. In an example of the payment industry, if more than 10 payment cards or cardholders have been identified to experience the anomalous event such as a BIN attack in the past in a particular payment card set or a particular cardholder set. Then each payment card in the corresponding payment card set or each cardholder in the corresponding cardholder set are labeled with the anomalous label such as a BIN attack label. Alternatively, in response to determining that the count is less than the threshold count, the labeling module 228 may label each entity in the entity set with a non-anomalous label. It is noted that these labels may act as true labels (see, 314, as shown in FIG. 1) while training the ML model 220. Also, the process of determining these true labels as explained herein can be referred to as ‘true label determination’ process (see, 316, as shown in FIG. 3). In an embodiment, the results of the labeling step and the series of feature sets are provided to the training module 230 for further processing.

In an embodiment, the training module 230 includes suitable logic and/or interfaces for generating a series of normalized feature sets for the series of time steps for each entity based, at least in part, on the series of feature sets and a normalization condition. For instance, values corresponding to the series of feature sets can be in a decimal format which are required to be normalized to binary states, such as a first state (e.g., ‘0’) and a second state (e.g., ‘1’) for easy processing and interpretation. In a non-limiting example, the normalization condition can include a condition to normalize or modify a format of the series of feature sets to a different format such as a normalized format. Upon generating the series of normalized feature sets, these feature sets may be stored in the database 204 which are accessible for future use.

In another embodiment, the training module 230 is configured to access the series of normalized feature sets from the database 204. Further, the training module 230 may train the ML model 220 to generate the prediction for an upcoming anomalous event based, at least in part, on the series of normalized feature sets and the labeling step. As the entity-related dataset 218 can be split into the training dataset, the testing dataset, and the validation dataset, the features such as the series of normalized feature sets can also be split into a series of normalized training feature sets, a series of normalized testing feature sets, and a series of normalized validation feature sets.

For training the ML model 220, in a non-limiting example, the training module 230 may access the series of normalized training feature sets for a series of training time steps corresponding to each training entity set of one or more training entity sets and a true label corresponding to each training entity in each training entity set from the database 204. Herein, the true label corresponds to one of the anomalous label or the non-anomalous label. Further, the training module 230 may initialize the ML model 220 with one or more model parameters.

In an embodiment, the one or more model parameters may be initialized based at least on the type of the model chosen for the ML model 220. In general, the one or more model parameters may include, but not be limited to, coefficients or weights associated with each feature, bias terms, regularization parameters, and the like. In another embodiment, the one or more model parameters may also include hyperparameters, such as leaning rate, epochs, kernel depth for SVM-based models, depth of trees for decision tree-based models, a number of layers, a number of neurons in a hidden layer of NN-based models, batch size, and the like. In yet another embodiment, when the ML model 220 is the Bi-LSTM model, the model parameters can include a learning rate, a batch size, a number of Bi-LSTM layers, weights, a number of epochs, a dimensionality of input features, an output size, a loss function, an optimizer, regularization parameters (e.g., dropout rate, L1 regularization, L2 regularization, etc.), activation functions, a merge mode, an input sequence length, and the like.

Upon initializing the one or more model parameters, the ML model 220 may be initialized based on the model parameters. Furthermore, the training module 230 may perform iteratively a set of operations until convergence criteria are met. It is noted that the set of operations is explained in terms of the configurations of various modules of the server system 200 such as the training module 230 using the ML model 220.

In an embodiment, the training module 230 is configured to generate a predicted probability score for each training entity set based, at least in part, on the series of normalized training feature sets for each training entity set. The predicted probability score may indicate a likelihood of at least one training entity set of the one or more training entity sets to experience the upcoming anomalous event at an upcoming training time step. The training module 230 may generate a prediction for the upcoming anomalous event based, at least in part, on the predicted probability score and the prediction threshold. The prediction may include the at least one training entity set that is likely to experience the upcoming anomalous event at the upcoming training time step. Later, the training module 230 may compute a prediction loss for each training entity set based, at least in part, on the prediction and the corresponding true label for the corresponding training entity set. Thereafter, the training module 230 may optimize the one or more model parameters based, at least in part, on the prediction loss. In a non-limiting example, the one or more model parameters may be optimized based on the backpropagation of the prediction loss. Upon optimization, the prediction loss may be reduced.

In a non-limiting implementation, for computing the prediction loss, a loss function may be used. In various examples, the loss function can be any loss function, such as mean squared error loss function, cross-entropy loss function, or the like, without limiting the scope of the proposed approach. Later, based on the prediction loss computed, the model parameters may be optimized, such that during the next iteration, the prediction loss reduces. Upon optimization of the model parameters, the ML model 220 may generate a new predicted probability score and the process repeats. This process is repeated until the convergence criteria are met. Herein, the convergence criteria may include saturation of the prediction loss. In an embodiment, the prediction loss may saturate after a plurality of iterations of the set of operations is performed. Herein, saturation may refer to a stage in the model training process after a certain number of iterations where a loss value (e.g., the prediction loss) becomes constant, i.e., the difference in the loss for one iteration and its subsequent iteration becomes the same or negligible. The prediction loss of any model is associated with model performance, so, the less the loss the better the model performance.

Once the convergence criteria are met, the ML model 220 may be able to generate the predicted probability score that is highly accurate, thereby generating a highly accurate prediction. Further, the ML model 220 may be tested and validated using the testing feature set and the validation feature set, respectively. Thereafter, the ML model 220 may be used for generating the prediction and hence provided to the prediction module 232.

In an embodiment, the prediction module 232 includes suitable logic and/or interfaces for generating an anomaly score (see, 318, as shown in FIG. 3) for the entity set based, at least in part, on the corresponding series of feature sets and the labeling step. Herein, the anomaly score may indicate a likelihood of the entity set to experience the upcoming anomalous event at the upcoming time step. For instance, the anomaly score is a predicted probability score ranging between 0 to 1.

Further, the prediction module 232 may generate the prediction (see, 320, as shown in FIG. 3) for the upcoming anomalous event based, at least in part, on the anomaly score and a prediction threshold. In one embodiment, the prediction module 232 generates the prediction indicating that the entity set is likely to experience the upcoming anomalous event at the upcoming time step. The prediction may be generated in response to the anomaly score being at least equal to the prediction threshold. In another embodiment, the prediction module 232 generates the prediction indicating that the entity set is not likely to experience the upcoming anomalous event at the upcoming time step in response to the anomaly score is less than the prediction threshold. For instance, if the anomaly score is greater than or equal to 0.9, then the prediction indicates that the entity set is likely to experience the upcoming anomalous event in the upcoming time step. If the anomaly score is less than 0.9, then the entity set is not likely to experience the upcoming anomalous event in the upcoming time step. In an example of the payment industry, if the anomaly score for a particular payment card set for a BIN attack prediction is greater than or equal to 0.9, then the corresponding payment card set is likely to experience a BIN attack in the future such as in the next 7 days. Alternatively, the payment card set may not experience the BIN attack in the next 7 days.

In an embodiment, the notification module 234 includes suitable logic and/or interfaces for periodically generating an alert for at least the entity set and a managing entity with a predefined period in response to the generation of the prediction for the upcoming anomalous event. The alert can be in the form of a text message, an email, a voice call, or the like. Also, the predefined period for periodically generating the alert can be configured by the managing entity of the server system 200. In response to receiving the alert for the upcoming anomalous event that can occur in the near future, the entities in the entity set and the managing entity can take preventive measures to prevent such an upcoming anomalous event. For example, if a BIN attack is predicted to occur after 7 days on a particular payment card set. Then the managing entity such as an issuer or the cardholders associated with the payment card set can take preventive measures, such as tokenization of card details, setting a transaction limit, enforcing additional authentication layers, etc., among other preventive measures.

In some embodiments, the prediction module 232 is configured to compute a feature importance metric associated with each feature from the plurality of features based, at least in part, on a contribution of the corresponding feature to the prediction of the ML model 220. In a non-limiting implementation, several techniques can be used for determining the contribution of the features to the generation of the prediction by the ML model 220. Various examples of such techniques can include model-based approaches, permutation importance approaches, Shapley Additive Explanation (SHAP)-based approach, a mutual information-based approach, and the like. It is noted that these approaches are well known to a person skilled in the art. To that end, these approaches are not described herein for the sake of brevity.

Further, the prediction module 232 may determine a set of relevant features from the plurality of features based, at least in part, on the feature importance metric associated with each feature and an importance threshold. The set of relevant features may be used to refine the prediction. For instance, a new series of feature sets for the series of time steps may be generated using the set of relevant features. These new series of feature sets may be used for generating the anomaly score, followed by the prediction. Since only relevant features that have contributed to the maximum for the prediction are considered, data complexity is reduced which in turn improves model efficiency. It also leads to faster training, reduced overfitting, and a simpler model generation.

FIG. 4 illustrates a schematic representation of an architecture 400 of an ML model such as the ML model 220 used for predicting the upcoming anomalous events, in accordance with an embodiment of the present disclosure. In an example scenario, the Bi-LSTM model can be considered for the implementation of the ML model 220. The architecture 400 shown in FIG. 4 is an architecture for the Bi-LSTM model. As may be understood, the Bi-LSTM model is a type of RNN that processes sequential data in both forward and backward directions. It is noted that the Bi-LSTM model combines the power of LSTM with bidirectional processing, allowing the model to capture both past and future context of the input sequence such as the series of feature sets or the series of the normalized feature sets. As the normalization step is performed on the series of feature sets by training module 230 of the server system 200, the series of normalized feature sets (see, 402, as shown in FIG. 4) are considered as input to the Bi-LSTM model. In an example, the series of normalized feature sets can include {NF₁, NF₂, . . . NF_{N}} (see, 402) for the series of time steps {1, 2, . . . T} for features such as the {X₁, X₂, X₃, X₄} (see, 312, of FIG. 3). Herein, it may be noted that ‘NF’ represents the normalized feature set and ‘N’ is a non-zero natural number indicating ‘N’ number of feature sets. Further, ‘T’ is also a non-zero natural number indicating time steps. Thus, it may be understood that NF1 has different values for {X₁, X₂, X₃, X₄}, NF2 has different values for {X₁, X₂, X₃, X₄}, and so on for different time steps. In a non-limiting example, each feature set in the series of normalized feature sets 402 can be represented as a vector or an embedding representation.

In an embodiment, the normalized feature sets 402 can be provided to the Bi-LSTM model as an input as shown in FIG. 4. As may be understood, the model includes two LSTM layers, such as a forward LSTM layer 404, and a backward LSTM layer 406. One of these layers processes the series of normalized feature sets 402 in a forward direction referred to as a ‘forward pass’ (see, 408) and the other layer processes it in a backward direction referred to as a ‘backward pass’ (see, 410). Further, it is noted that each layer maintains its own hidden states and memory cells.

In the forward pass 408, the series of normalized feature sets 402 are fed into the forward LSTM layer 404 from a first time step to a last time step, i.e., from the time step ‘1’ to the time step ‘T’. At each time step, LSTM modules (labeled as ‘LSTM’ in FIG. 4) in the forward LSTM layer 404 compute their hidden states, such as \vec{H}₁, \vec{H}₂, . . . , \vec{H}_{N} (see, 412) and updates its memory cell based on the current input and the previous hidden state and the memory cell.

Simultaneously, the series of normalized feature sets 402 are fed into the backward LSTM layer 406, in the backward pass 410, in a reverse order from the last time step to the first time step, i.e., from the time step ‘T’ to the time step ‘1’. Similar to the forward pass 408, LSTM modules in the backward LSTM layer 406 compute its hidden states, such as \acute{H}₁, \acute{H}₂, . . . , \acute{H}_{N} (see, 414) and update its memory cell based on the current input and the previous hidden state and the memory cell. Both the layers 404 and 406 can have a predefined count of LSTM modules. For example, the predefined count can be 64 units. It is noted that this predefined count may vary for different applications.

In response to the completion of the forward pass 408 and the backward pass 410, the hidden states 412 and 414 from both the layers 404 and 406, respectively are combined at each time step. In a non-limiting implementation, the combination can be performed using a simple concatenation process (see, 416). Alternatively, some other transformation operations may be performed for the combination of the hidden states, without limiting the scope of the present disclosure. During the forward pass 408, the forward LSTM layer 404 captures information from the past (previous time steps), while during the backward pass 410, the backward LSTM layer 406 captures information from the future (following time steps). To conclude, as the Bi-LSTM model captures both past and future information, it can capture richer dependencies in the input sequence such as the series of feature sets.

In an example scenario, while training the Bi-LSTM model, along with the loss function for computing the prediction loss, L1/L2 regularization may be considered. In a non-limiting example implementation, L1/L2 regularization can have a value of 0.3. Moreover, in an example, the combination step may be implemented by applying an attention mechanism to the hidden states 412 and 414. For instance, the attention mechanism can include assigning different weights to the hidden states 412 and 414 at each time step while combining them.

In a specific embodiment, the two layers 404 and 406 may be followed by a dense layer 418. In an example, the dense layer 418 can have 32 units or neurons with a dropout of 0.3. In another embodiment, the dense layer 418 can be followed by another dense layer such as the dense layer 420. In an example, the dense layer 420 can have a single unit or a single neuron with a dropout of 0.3. In some embodiments, the dense layers, such as the dense layers 418 and 420 can use an activation function such as a sigmoid function which transforms probability values to range between 0 and 1. A binary cross entropy loss can be considered for the loss function and an Adam optimizer for the optimization of the model parameters. In an example, based on these features of the model, the model can be trained for about 200 epochs with early stopping in case the prediction loss does not change for the last 25 epochs.

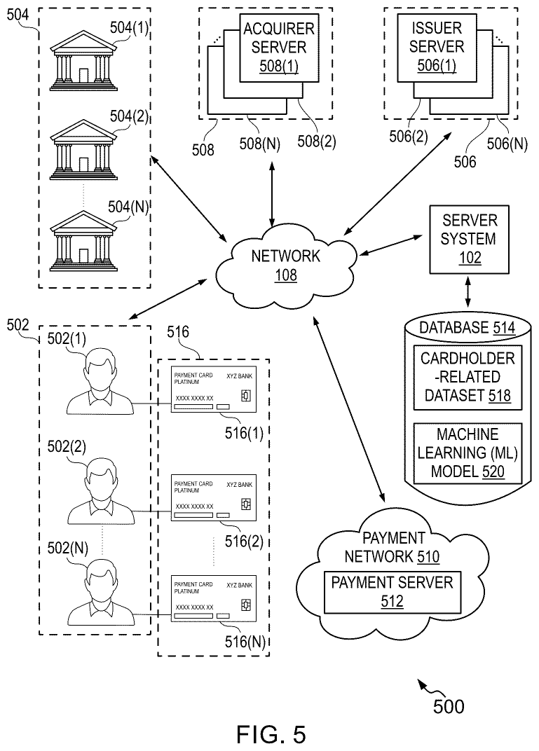

FIG. 5 illustrates a schematic representation of another environment 500 related to at least some example embodiments of the present disclosure. Although the environment 500 is presented in one arrangement, other embodiments may include the parts of the environment 500 (or other parts) arranged otherwise depending on, operations performed similar to that performed in the environment 100. Thus, it should be noted that the environment 500 is an example implementation of the environment 100, with the environment 500 representing a financial industry in which the entities 104 can be at least one of cardholders and merchants. Thus, the data points of data samples or events in the environment 100 may correspond to payment transactions performed between the cardholders and the merchants in the environment 500.

In one embodiment, the environment 500 includes parties, such as the server system 102, a plurality of cardholders 502(1), 502(2), . . . 502(N) (collectively referred to hereinafter as a ‘plurality of cardholders 502’ or simply ‘cardholders 502’), a plurality of merchants 504(1), 504(2), . . . 504(N) (collectively referred to hereinafter as a ‘plurality of merchants 504’ or simply ‘merchants 504’), a plurality of issuer servers 506(1), 506(2), . . . 506(N) (collectively referred to hereinafter as a ‘plurality of issuer servers 506’ or simply ‘issuer servers 506’), a plurality of acquirer servers 508(1), 508(2), . . . , 508(N) (collectively referred to hereinafter as a ‘plurality of acquirer servers 508’ or simply ‘acquirer servers 508’), a payment network 510 including a payment server 512, and the database 514 each coupled to, and in communication with (and/or with access to) the network 110. Herein, it may be noted that ‘N’ is a non-zero natural number that may be different for each entity.

In an embodiment, the plurality of cardholders 104 use one or more payment cards 516(1), 516(2), . . . 516(N) (collectively, referred to hereinafter as a ‘plurality of payment cards 516’ or simply ‘payment cards 516’ and ‘N’ is a Natural number) respectively to make payment transactions. The term “cardholder” (such as the cardholder 502(1)) refers to a person who has a payment account or a payment card such as the payment card 516(1) (e.g., credit card, debit card, etc.) associated with the payment account, that will be used by a merchant (such as the merchant 504(1)) to perform a payment transaction. The payment account may be opened via an issuing bank or an issuer server (e.g., the issuer server 506(1)).

Similarly, as used herein, the term “merchant” refers to a seller, a retailer, a purchase location, an organization, or any other entity that is in the business of selling goods or providing services, and it can refer to either a single business location or a chain of business locations of the same entity. Further, as used herein, the term “payment network” (such as the payment network 510) refers to a network or collection of systems used for the transfer of funds through the use of cash substitutes. Payment networks are companies that connect an issuing bank with an acquiring bank to facilitate digital payments between the cardholders 502 and the merchants 504. In an example, the cardholders 502 may use their corresponding electronic devices (not shown) to access a mobile application or a website associated with the merchants 504 or the issuing banks, or any third-party payment application to perform a payment transaction.

In one embodiment, the payment network 510 may be used by the payment card issuing authorities as a payment interchange network. Examples of the payment cards 516 include debit cards, credit cards, etc. A payment interchange network allows for the exchange of electronic payment transaction data between issuers and acquirers. The payment network 510 includes the payment server 512 which is responsible for facilitating the various operations of the payment network 510. In one scenario, the payment server 512 is configured to operate a payment gateway for facilitating the various parties in the payment network 510 to perform digital transactions.

It is noted that due to the complexity of a banking network, a cardholder 502(1) and a merchant 504(1) may be associated with the same banking institution, e.g., ABC Bank. In such a situation, the ABC Bank will act as an issuer for the cardholder 502(1) and an acquirer for the merchant 504(1). Thus, a banking institution may act as both an acquirer and/or an issuer depending on the needs of its clients.

As may be understood, in the financial industry, various operations such as fraud detection are performed using various AI or ML models. Conventionally, these operations are performed in real time, i.e., immediately after the occurrence of an event such as a fraudulent attack. Other conventional approaches can provide predictions related to these operations prior to the occurrence of the event. However, such approaches do not provide accurate results and are complex in implementation. It is noted that conventional approaches are also associated with several other drawbacks as explained earlier. These drawbacks and other drawbacks are addressed by one or more embodiments implemented by the server system 102 and the methods thereof provided in the present disclosure.

In one embodiment, the server system 102 may facilitate payment processors to predict the upcoming anomalous events on the cardholders 502 and/or the payment cards 516. It may be noted that, in a specific example, the server system 102 coupled with the database 514 is embodied within a payment server (e.g., the payment server 512) associated with the payment processor, however, in other examples, the server system 102 can be a standalone component (acting as a hub) connected to the issuer servers 506 and the acquirer servers 508.

In one embodiment, the database 514 may be configured to store a cardholder-related dataset 518. Along with this, the database 514 may also store a merchant-related dataset and any other historical information that may be related to a plurality of payment transactions performed between the cardholders 502 and the merchants 504 in a payment ecosystem. The cardholder-related dataset 518 may include information related to the cardholders 502 interacting with the merchants 504. The information can be historical information or information that is captured in real-time. In an example, the information may include, but is not limited to, transaction attributes, such as transaction amount, source of funds such as bank accounts, debit cards or credit cards, transaction channel used for loading funds such as POS terminal or ATM, transaction velocity features such as count and transaction amount sent in the past ‘x’ number of days to a particular user, transaction location information, external data sources, merchant country, merchant Identifier (ID), cardholder ID, cardholder product, cardholder Permanent Account Number (PAN), Merchant Category Code (MCC), merchant location data or merchant co-ordinates, merchant industry, merchant super industry, ticket price, and other transaction-related data.

In other various examples, the database 514 may also include multifarious data, for example, social media data, Know Your Customer (KYC) data, payment data, trade data, employee data, Anti Money Laundering (AML) data, market abuse data, Foreign Account Tax Compliance Act (FATCA) data, and fraudulent payment transaction data.

By accessing the cardholder-related dataset 518, the server system 102 is configured to generate a prediction for the upcoming anomalous events using an ML model such as the ML model 520 by performing various operations. It should be noted that the operations are explained above with reference to FIG. 1 to FIG. 4 and not described again for the sake of brevity. However, a brief about these operations is covered herein for clarity.

In a non-limiting implementation, various features may be generated from the cardholder-related dataset 518 using the data pre-processing module 224 of the server system 102. These features are used for training the ML model 520 for generating the prediction. Various examples of the features can include total declined Card Not Present (CNP) cross border transactions, total transactions with declined Card Present (CP) cross border transactions having a risk score in the predefined range, total domestic CP transactions that are reported fraud, total cross border CNP declined transactions with an amount less than 1 USD, and the like. Various other examples of the features based on a first-seen activity on the payment network 510 can include, but not limited to, total transactions from cross-border CNP transactions where the payment cards 516 were first seen on payment network 510 in last 7 days/15 days/30 days, total distinct declined PANs doing cross border CNP transactions where the payment cards 516 were first seen on payment network 510 in last 7 days/15 days/30 days, total transactions from cross border CNP transactions where the merchants 504 were first seen on payment network 510 in last 7 days/15 days/30 days, total domestic CP transactions that are reported fraud and the merchant such as the merchant 504(1) was seen first time on payment network 510 in last 7 days/15 days/30 days, and the like.

Various examples of the features based on authentication response codes can include, but are not limited to, a count of distinct PANs across different response codes, total transaction count across different response codes, and the like. Some other examples of the features can include total domestic CNP transaction count having the risk score in the predefined range, total domestic CP transaction count having the risk score in the predefined range, total distinct PANs doing cross border CNP transactions, total distinct PANs doing domestic CNP transactions where the PANs are first seen on the payment network 510 in last 15 days, total transactions with response code 43 (i.e., for stolen cards), total distinct PANs with response code 43, total distinct PANs doing domestic CP transactions, total distinct PANs doing domestic CNP transactions where card is first seen on the payment network 510 in last 7 days, total declined amount from CNP domestic transactions, total transaction amount from domestic CNP transactions where the merchant 504 was first seen on the payment network 510 in last 30 days, and the like.

In an example scenario of the environment 500, it may be required to predict whether a payment card set (otherwise, also referred to as an ‘account range’) will face a BIN attack in the next 7 days. Herein, the account range can be considered as a subset of a BIN of payment cards. Initially, data corresponding to the payment card set is extracted from the data sources such as an authentication (AUTH) data source, a debit data source, and the like, that are associated with the payment network 510. This data may be a part of the cardholder-related dataset 518. The features, as described earlier are generated from the extracted data using the data pre-processing module 224. In some embodiments, some of the features are also generated from PANs that were leaked on the dark website. In an embodiment, a series of feature sets for a series of time steps are generated from these features using the filtering module 226. In an example, each time step can correspond to one day. For each timestep, values corresponding to a total of 465 features can be created in this step. The data for the past 90 days from the day of the prediction is extracted in this step.

These features are further scaled to range between binary states such as 0 and 1 for the features to be consistent across different examples using the training module 230. The scaling or the normalization of these features can be performed by dividing each feature value by the maximum value of that feature in the last 90 days. This changes all the values for all the features between the binary states (i.e., between 0 to 1). Then, these features are changed to a 3-Dimensional (3D) array, which is a suitable input for providing to the ML model 220. Since the prediction is for the payment card set, the first dimension would be 1. The second dimension corresponds to the number of timesteps, so it would be 90. The third dimension corresponds to a number of features so it would be 465. Thus, an array of (1, 90, 465) is considered for the series of feature sets. Further, these normalized features are fed to the ML model 520. It is noted that the ML model 520 is trained with labels which can be either 0 or 1 based on whether the payment card set was under BIN attack in the last 7 days or not using the training module 230. Herein, true labels for the prediction are determined by the labeling module 228. During prediction, the ML model 520 generates the anomaly score between 0 to 1, with a score closer to 1 indicating a higher likelihood of the payment card set facing a BIN attack in the next 7 days. Early prediction of BIN attacks enables the financial institutions to implement preventive measures, reducing the risk of BIN attacks in the future.

As may be appreciated, the approach described by the present disclosure can easily be scaled and applied to various applications specific to different industries with minor modifications. It is noted that such applications are also covered within the scope of the present disclosure.

In a non-limiting implementation, several experiments have been conducted to determine the performance of the ML model 220. One such experiment can include measuring performance parameters, such as a receiver operating characteristics (ROC) curve, a precision-recall (PR) curve, and the like for different input datasets. In general, a ROC curve shows how well a model performs across all possible thresholds. It is a plot of a true positive rate against a false positive rate at each threshold setting. The area under the ROC curve (AU-ROC) may be computed to measure the performance of the model such as the ML model 220. Similarly, in general, a PR curve is a trade-off between precision and recall for a model. The term ‘precision’ can be defined as a ratio of true positives to the sum of true and false positives. It measures the relevancy of the results. The term ‘recall’ refers to a ratio of true positives to the sum of true positives and false negatives. It measures the completeness of the results. The area under the PR curve (AUC-PR) may be computed to measure the performance of the model such as the ML model 220.

Various embodiments of the present disclosure are advantageous in comparison to conventional approaches for various reasons. One such reason is that the conventional approaches does not generate the alert on a daily basis but after the occurrence of the anomalous event. Further, it may also be observed that the prediction generated by the ML model 220 for upcoming anomalous events matches the alerts that the conventional approaches generate after the occurrence of the anomalous event. As a result, the results obtained from the ML model 220 are accurate and valid.

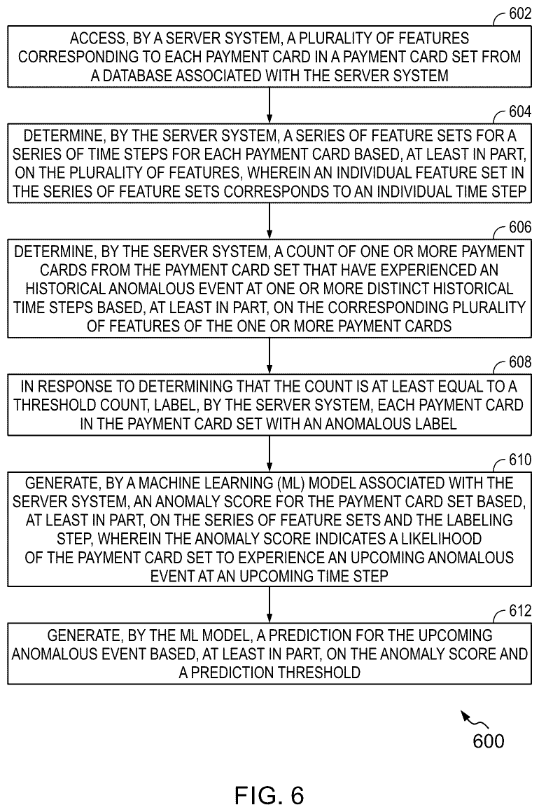

FIG. 6 illustrates a flow diagram depicting a method 600 for predicting upcoming anomalous events in financial domain, in accordance with an embodiment of the present disclosure. The method 600 depicted in the flow diagram may be executed by, for example, the server system 200. The sequence of operations of the method 600 may not be necessarily executed in the same order as they are presented. Further, one or more operations may be grouped and performed in the form of a single step, or one operation may have several sub-steps that may be performed parallelly or sequentially. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At operation 602, the method 600 includes accessing, by a server system (e.g., the server system 102), a plurality of features corresponding to each payment card in a payment card set from a database (e.g., the database 514) associated with the server system 102.

At operation 604, the method 600 includes determining, by the server system 102, a series of feature sets for a series of time steps for each payment card based, at least in part, on the plurality of features. An individual feature set in the series of feature sets may correspond to an individual time step.

At operation 606, the method 600 includes determining, by the server system 102, a count of one or more payment cards from the payment card set that have experienced a historical anomalous event at one or more distinct historical time steps based, at least in part, on the corresponding plurality of features of the one or more payment cards.

At operation 608, the method 600 includes in response to determining that the count is at least equal to a threshold count, labeling, by the server system 102, each payment card in the payment card set with an anomalous label.

At operation 610, the method 600 includes generating, by a Machine Learning (ML) model (e.g., the ML model 520) associated with the server system 102, an anomaly score for the payment card set based, at least in part, on the corresponding series of feature sets and the labeling step. Herein, the anomaly score may indicate a likelihood of the payment card set to experience an upcoming anomalous event at an upcoming time step.

At operation 612, the method 600 includes generating, by the ML model 520, a prediction for the upcoming anomalous event based, at least in part, on the anomaly score and a prediction threshold.

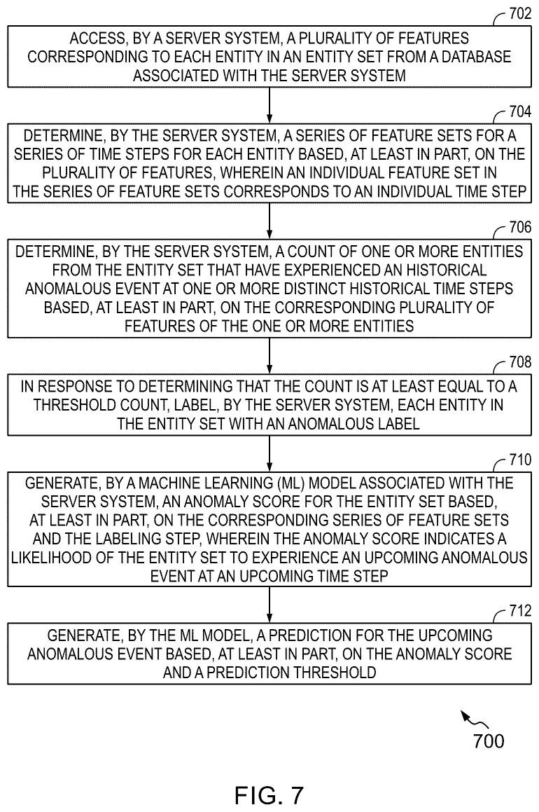

FIG. 7 illustrates a flow diagram depicting a method 700 for predicting upcoming anomalous events, in accordance with an embodiment of the present disclosure. The method 700 depicted in the flow diagram may be executed by, for example, the server system 200. The sequence of operations of the method 700 may not be necessarily executed in the same order as they are presented. Further, one or more operations may be grouped and performed in the form of a single step, or one operation may have several sub-steps that may be performed parallelly or sequentially. Operations of the method 700, and combinations of operations in the method 700 may be implemented by, for example, hardware, firmware, a processor, circuitry, and/or a different device associated with the execution of software that includes one or more computer program instructions. The plurality of operations is depicted in the process flow of the method 700. The process flow starts at operation 702.

At operation 702, the method 700 includes accessing, by a server system (e.g., the server system 200), a plurality of features (e.g., the features 302) corresponding to each entity in an entity set from a database (e.g., the database 204) associated with the server system 200.

At operation 704, the method 700 includes determining, by the server system 200, a series of feature sets (e.g., the feature sets 306) for a series of time steps (e.g., the time steps 308) for each entity based, at least in part, on the plurality of features (e.g., the features 302). An individual feature set in the series of feature sets (e.g., the feature sets 306) may correspond to an individual time step.

At operation 706, the method 700 includes determining, by the server system 200, a count of one or more entities from the entity set that have experienced a historical anomalous event at one or more distinct historical time steps based, at least in part, on the corresponding plurality of features (e.g., the features 302) of the one or more entities.

At operation 708, the method 700 includes in response to determining that the count is at least equal to a threshold count, labeling, by the server system 200, each entity in the entity set with an anomalous label.

At operation 710, the method 700 includes generating, by a Machine Learning (ML) model (e.g., the ML model 220) associated with the server system 200, an anomaly score (e.g., the anomaly score 318) for the entity set based, at least in part, on the corresponding series of feature sets (e.g., the feature sets 306) and the labeling step. Herein, the anomaly score 318 may indicate a likelihood of the entity set to experience an upcoming anomalous event at an upcoming time step.

At operation 712, the method 700 includes generating, by the ML model 220, a prediction (e.g., the prediction 320) for the upcoming anomalous event based, at least in part, on the anomaly score 318 and a prediction threshold.

The disclosed methods with reference to FIG. 6 and FIG. 7, or one or more operations of the server system 200 may be implemented using software including computer-executable instructions stored on one or more computer-readable media (e.g., non-transitory computer-readable media, such as one or more optical media discs, volatile memory components (e.g., Dynamic Random Access Memory (DRAM) or Statis Random Access Memory (SRAM)), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication mode. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable CD-R, Compact Disc Rewritable CD-R/W), Digital Versatile Disc (DVD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a plurality of features corresponding to each entity in an entity set from a database associated with the server system;
determining, by the server system, a series of feature sets for a series of time steps for each entity based, at least in part, on the plurality of features, wherein an individual feature set in the series of feature sets corresponds to an individual time step;
determining, by the server system, a count of one or more entities from the entity set that have experienced a historical anomalous event at one or more distinct historical time steps based, at least in part, on the corresponding plurality of features of the one or more entities;
in response to determining that the count is at least equal to a threshold count, labeling, by the server system, each entity in the entity set with an anomalous label;
generating, by a Machine Learning (ML) model associated with the server system, an anomaly score for the entity set based, at least in part, on the corresponding series of feature sets and the labeling step, wherein the anomaly score indicates a likelihood of the entity set to experience an upcoming anomalous event at an upcoming time step; and
generating, by the ML model, a prediction for the upcoming anomalous event based, at least in part, on the anomaly score and a prediction threshold.

2. The computer-implemented method as claimed in claim 1, further comprising:
accessing, by the server system, a series of normalized feature sets for the series of time steps from the database; and
training, by the server system, the ML model to generate the prediction for the upcoming anomalous event based, at least in part, on the series of normalized feature sets and the labeling step.

3. The computer-implemented method as claimed in claim 2, wherein accessing the series of normalized feature sets comprises:
generating, by the server system, the series of normalized feature sets for the series of time steps for each entity based, at least in part, on the series of feature sets and a normalization condition.

4. The computer-implemented method as claimed in claim 2, wherein training the ML model comprises:
accessing, by the server system, a series of normalized training feature sets for a series of training time steps corresponding to each training entity set of one or more training entity sets and a true label corresponding to each training entity in each training entity set from the database, wherein the true label corresponds to one of an anomalous label or a non-anomalous label;
initializing, by the server system, the ML model with one or more model parameters; and
performing iteratively, by the server system, until convergence criteria are met, a set of operations comprising:
generating, by the ML model, a predicted probability score for each training entity set based, at least in part, on the series of normalized training feature sets for each training entity set, the predicted probability score indicating a likelihood of at least one training entity set of the one or more training entity sets to experience the upcoming anomalous event at an upcoming training time step;
generating, by the ML model, a prediction for the upcoming anomalous event based, at least in part, on the predicted probability score and the prediction threshold, the prediction comprising the at least one training entity set that is likely to experience the upcoming anomalous event at the upcoming training time step;
computing, by the ML model, a prediction loss for each training entity set based, at least in part, on the prediction and the corresponding true label for the corresponding training entity set; and
optimizing, by the ML model, the one or more model parameters based, at least in part, on the prediction loss.

5. The computer-implemented method as claimed in claim 1, further comprising:
in response to determining that the count is less than the threshold count, labeling, by the server system, each entity in the entity set with a non-anomalous label.

6. The computer-implemented method as claimed in claim 1, wherein generating the prediction for the upcoming anomalous event comprises one of:
in response to the anomaly score being at least equal to the prediction threshold, generating, by the server system, the prediction indicating that the entity set is likely to experience the upcoming anomalous event at the upcoming time step; or
in response to the anomaly score is less than the prediction threshold, generating, by the server system, the prediction indicating that the entity set is not likely to experience the upcoming anomalous event at the upcoming time step.

7. The computer-implemented method as claimed in claim 1, further comprising:
computing, by the server system, a feature importance metric associated with each feature from the plurality of features based, at least in part, on a contribution of the corresponding feature to the prediction of the ML model; and
determining, by the server system, a set of relevant features from the plurality of features based, at least in part, on the feature importance metric associated with each feature and an importance threshold, wherein the set of relevant features is used to refine the prediction.

8. The computer-implemented method as claimed in claim 1, further comprising:
periodically generating, by the server system, an alert for at least the entity set and a managing entity with a predefined period in response to the generation of the prediction for the upcoming anomalous event.

9. The computer-implemented method as claimed in claim 1, further comprising:
accessing, by the server system, an entity-related dataset from the database, the entity-related dataset comprising information related to a plurality of entities;
generating, by the server system, the plurality of features corresponding to each entity based, at least in part, on the information related to the plurality of entities; and
storing, by the server system, the plurality of features in the database.

10. The computer-implemented method as claimed in claim 9, further comprising:
generating, by the server system, the entity set comprising the one or more entities and one or more related entities based, at least in part, on the plurality of features corresponding to each entity in the plurality of entities, wherein the one or more related entities are identified from the plurality of entities based on a predefined relation condition.

11. A server system, comprising:
a memory configured to store instructions;
a communication interface; and
a processor in communication with the memory and the communication interface, the processor configured to execute the instructions stored in the memory and thereby cause the server system to perform at least in part to:
access a plurality of features corresponding to each entity in an entity set from a database associated with the server system;
determine a series of feature sets for a series of time steps for each entity based, at least in part, on the plurality of features, wherein an individual feature set in the series of feature sets corresponds to an individual time step;
determine a count of one or more entities from the entity set that have experienced a historical anomalous event at one or more distinct historical time steps based, at least in part, on the corresponding plurality of features of the one or more entities;
in response to determining that the count is at least equal to a threshold count, label each entity in the entity set with an anomalous label;
generate, by a Machine Learning (ML) model associated with the server system, an anomaly score for the entity set based, at least in part, on the corresponding series of feature sets and the labeling step, wherein the anomaly score indicates a likelihood of the entity set to experience an upcoming anomalous event at an upcoming time step; and
generate, by the ML model, a prediction for the upcoming anomalous event based, at least in part, on the anomaly score and a prediction threshold.

12. The server system as claimed in claim 11, wherein the server system is further caused, at least in part, to:
access a series of normalized feature sets for the series of time steps from the database; and
train the ML model to generate the prediction for the upcoming anomalous event based, at least in part, on the series of normalized feature sets and the labeling step.

13. The server system as claimed in claim 12, wherein to access the series of normalized feature sets, the server system is further caused, at least in part, to generate the series of normalized feature sets for the series of time steps for each entity based, at least in part, on the series of feature sets and a normalization condition.

14. The server system as claimed in claim 12, wherein to train the ML model, the server system is further caused, at least in part, to:
access a series of normalized training feature sets for a series of training time steps corresponding to each training entity set of one or more training entity sets and a true label corresponding to each training entity in each training entity set from the database, wherein the true label corresponds to one of an anomalous label or a non-anomalous label;
initialize the ML model with one or more model parameters; and
perform iteratively until convergence criteria are met, a set of operations comprising:
generating, by the ML model, a predicted probability score for each training entity set based, at least in part, on the series of normalized training feature sets for each training entity set, the predicted probability score indicating a likelihood of at least one training entity set of the one or more training entity sets to experience the upcoming anomalous event at an upcoming training time step;
generating, by the ML model, a prediction for the upcoming anomalous event based, at least in part, on the predicted probability score and the prediction threshold, the prediction comprising the at least one training entity set experiencing the upcoming anomalous event at the upcoming training time step;
computing, by the ML model, a prediction loss for each training entity set based, at least in part, on the prediction and the corresponding true label for the corresponding training entity set; and
optimizing, by the ML model, the one or more model parameters based, at least in part, on the prediction loss.

15. The server system as claimed in claim 11, wherein the server system is further caused, at least in part, to label each entity in the entity set with a non-anomalous label in response to determining that the count is less than the threshold count.

16. The server system as claimed in claim 11, wherein the server system is further caused, at least in part, to:
generate the prediction indicating that the entity set is likely to experience the upcoming anomalous event at the upcoming time step, in response to the anomaly score being at least equal to the prediction threshold; and
generate the prediction indicating that the entity set is not likely to experience the upcoming anomalous event at the upcoming time step, in response to the anomaly score is less than the prediction threshold.

17. The server system as claimed in claim 11, wherein the server system is further caused, at least in part, to:
compute a feature importance metric associated with each feature from the plurality of features based, at least in part, on a contribution of the corresponding feature to the prediction of the ML model; and
determine a set of relevant features from the plurality of features based, at least in part, on the feature importance metric associated with each feature and an importance threshold, wherein the set of relevant features is used to refine the prediction.

18. The server system as claimed in claim 11, wherein the server system is further caused, at least in part, to periodically generate an alert for at least the entity set and a managing entity with a predefined period in response to the generation of the prediction for the upcoming anomalous event.

19. The server system as claimed in claim 11, wherein the server system is further caused, at least in part, to:
access an entity-related dataset from the database, the entity-related dataset comprising information related to a plurality of entities;
generate the plurality of features corresponding to each entity based, at least in part, on the information related to the plurality of entities; and
generate the entity set comprising the one or more entities and one or more related entities based, at least in part, on the plurality of features corresponding to each entity in the plurality of entities, wherein the one or more related entities are identified from the plurality of entities based on a predefined relation condition.

20. A non-transitory computer-readable storage medium comprising computer-executable instructions that, when executed by at least a processor of a server system, cause the server system to perform a method comprising:
accessing a plurality of features corresponding to each entity in an entity set from a database associated with the server system;
determining a series of feature sets for a series of time steps for each entity based, at least in part, on the plurality of features, wherein an individual feature set in the series of feature sets corresponds to an individual time step;
determining a count of one or more entities from the entity set that have experienced a historical anomalous event at one or more distinct historical time steps based, at least in part, on the corresponding plurality of features of the one or more entities;
in response to determining that the count is at least equal to a threshold count, labeling each entity in the entity set with an anomalous label;
generating, by a Machine Learning (ML) model associated with the server system, an anomaly score for the entity set based, at least in part, on the corresponding series of feature sets and the labeling step, wherein the anomaly score indicates the likelihood of the entity set to experience an upcoming anomalous event at an upcoming time step; and
generating, by the ML model, a prediction for the upcoming anomalous event based, at least in part, on the anomaly score and a prediction threshold.
